(19) United States
(12) Patent Application Publication
(10) Pub. No.: US 2013/0342450 A1
(43) Pub. Date: Dec. 26, 2013

(54) ELECTRONIC DEVICES

(71) Applicant: Hideaki Tetsuhashi, Tokyo (JP)

(72) Inventor: Hideaki Tetsuhashi, Tokyo (JP)

(73) Assignee: NEC CORPORATION, Tokyo (JP)

(21) Appl. No.: 14/003,012

(22) PCT Filed: Feb. 21, 2012
(86) PCT No.: PCT/JP2012/054100

§ 371 Date: Sep. 4, 2013

(30) Foreign Application Priority Data
Mar. 29, 2011 (JP) 2011-072485

(51) Int. Cl. G06F 3/01

(52) U.S. Cl. CPC G06F 3/011
USPC 345/156

(57) ABSTRACT

Sensors (120-1) to (120-2) detect motion of a target or shape of a target or motion and shape of a target. Display section (140) displays an icon that denotes that sensors (120-1) to (120-2) are detecting the target.

### TECHNICAL FIELD

The present invention relates to electronic devices, notification methods, and programs, in particular to electronic devices that use sensors and notification methods and programs for the electronic devices.

### BACKGROUND ART

In recent years, electronic devices such as PCs (personal computers) and mobile terminals that are provided with sensors that detect motion, shape, and so forth of a target have been released.

For example, electronic devices that are provided with a camera as a sensor that captures an image of a user's face and determines whether or not his or her face has been registered are known (for example, refer to Patent Literature 1).

In addition, electronic devices that are provided with a plurality of sensors that determine the face and motion of the user have been released. For example, in these electronic devices, while one camera detects the user's face, the other camera detects his or her motion.

### RELATED ART LITERATURE

### Patent Literature

Patent Literature 1: JP2009-064140A, Publication

### SUMMARY OF THE INVENTION

### Problem to be Solved by the Invention

In the forgoing electronic devices provided with a plurality of sensors, the user cannot know which one of the sensors is currently operating. Thus, while the electronic device is detecting the user's face, he or she may be convinced that the electronic device is detecting his or her hand and may move his or her hand, Consequently, a problem arises. In other words, the user's expected result may differ from the result detected by the electronic device.

In addition, while a sensor is detecting a user's face, the electronic device displays the captured image as a preview image on the screen of the built-in display section or the like. At this point, a problem arises. In other words, since the electronic device displays the preview image on a large part of the display area of the screen, the user needs to stop his or her current operation. For example, while the user is inputting text into the electronic device, if he or she needs to perform face authentication (for example, site connection authentication), the preview screen hides the text input screen. Thus, the user should stop the text input operation.

An object of the present invention is to provide electronic devices, notification methods, and programs that can solve the foregoing problems.

### Means that Solve the Problem

An electronic device according to the present invention includes a sensor that detects motion of a target or shape of a target or motion and shape of a target; and a display section that displays an icon that denotes that said sensor is detecting the target.

A notification method according to the present invention is a notification method that notifies a user who uses an electronic device of information, including processes of causing a sensor to detect motion of a target or shape of a target or motion and shape of a target; and displaying an icon that denotes that said sensor is detecting the target.

A program according to the present invention is a program that causes an electronic device to execute the procedures including causing a sensor to detect motion of a target or shape of a target or motion and shape of a target; and displaying an icon that denotes that said sensor is detecting the target.

### Effect of the Invention

As described above, according to the present invention, the user can recognize a target that a sensor is detecting without it being necessary to stop the operation of a device that is currently being performed while he or she is watching the screen.

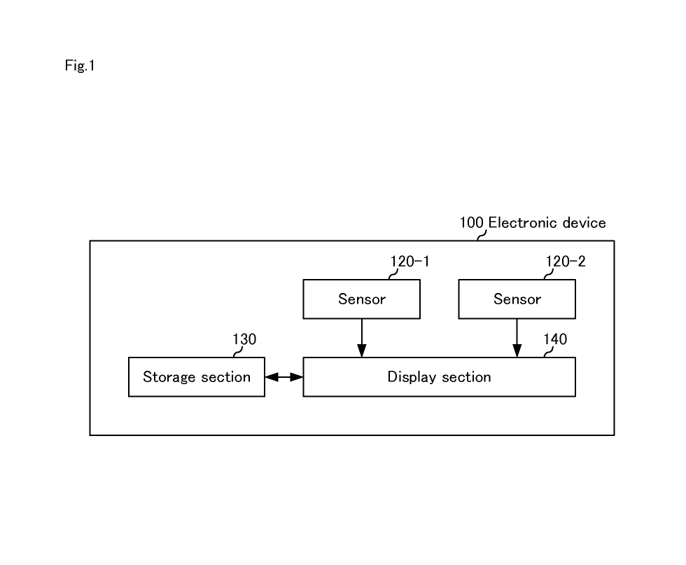

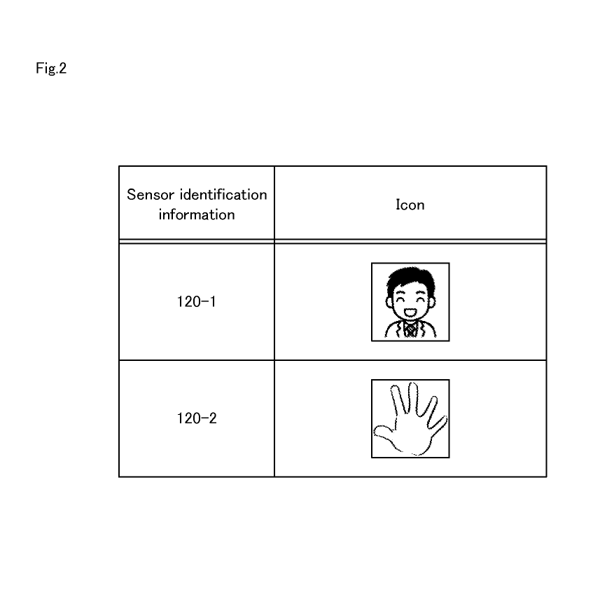

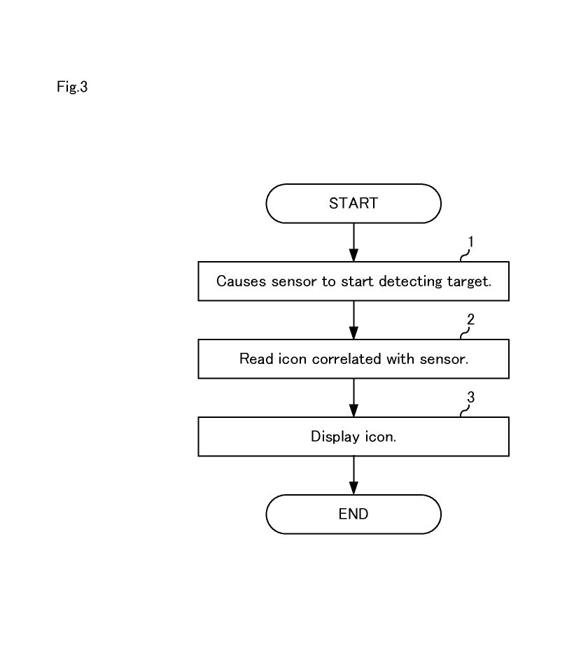

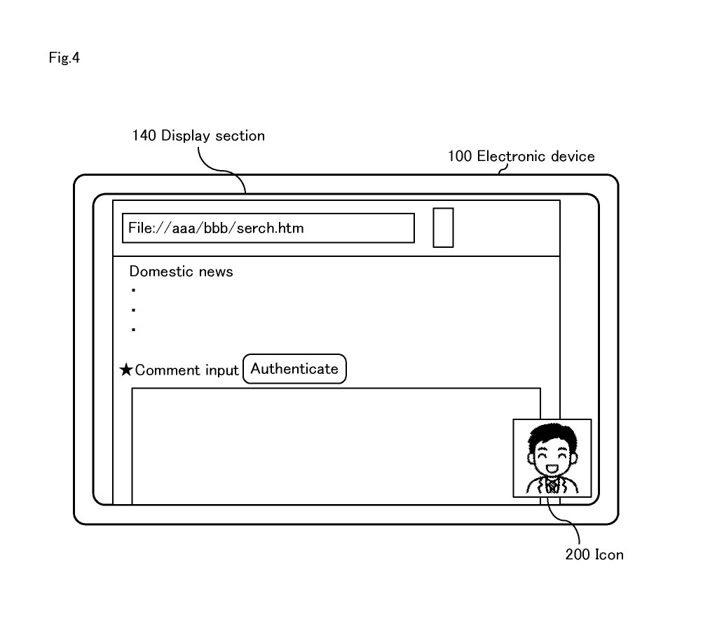

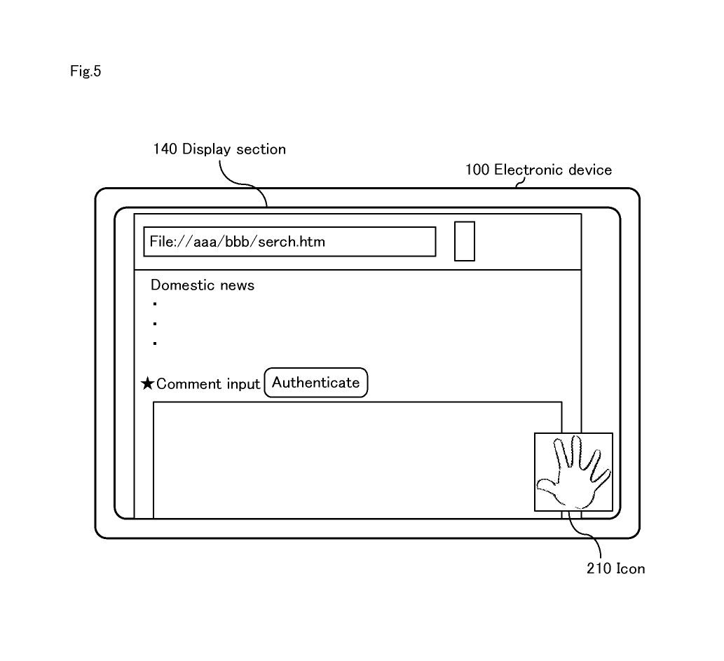

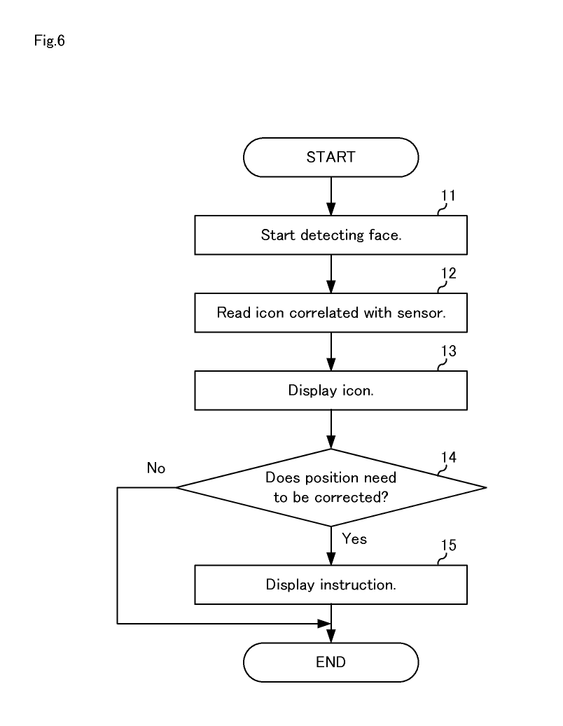

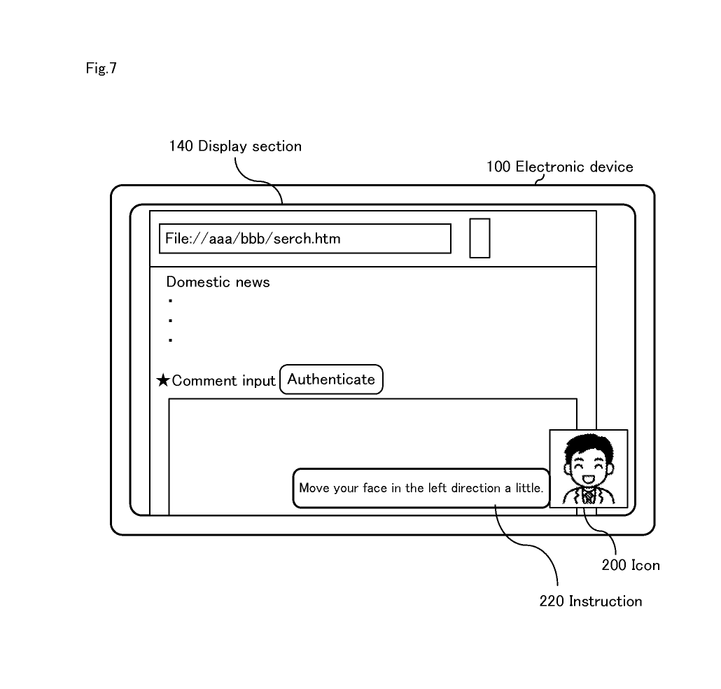

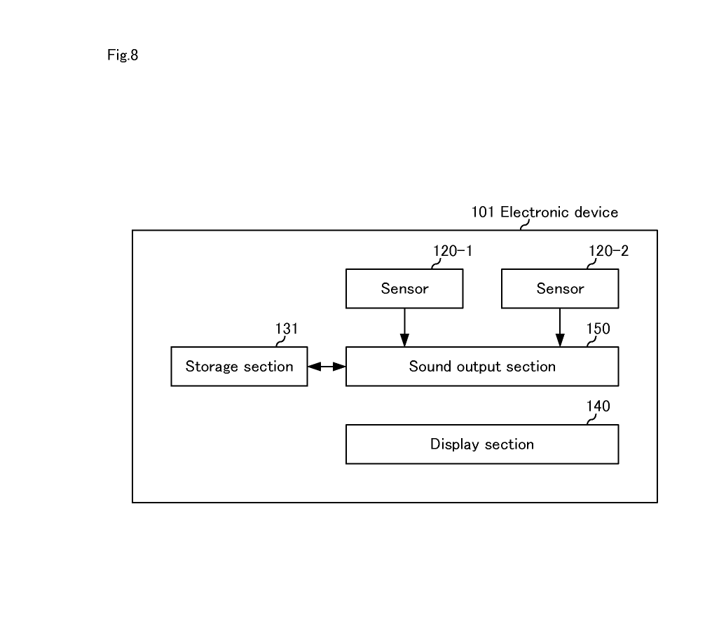

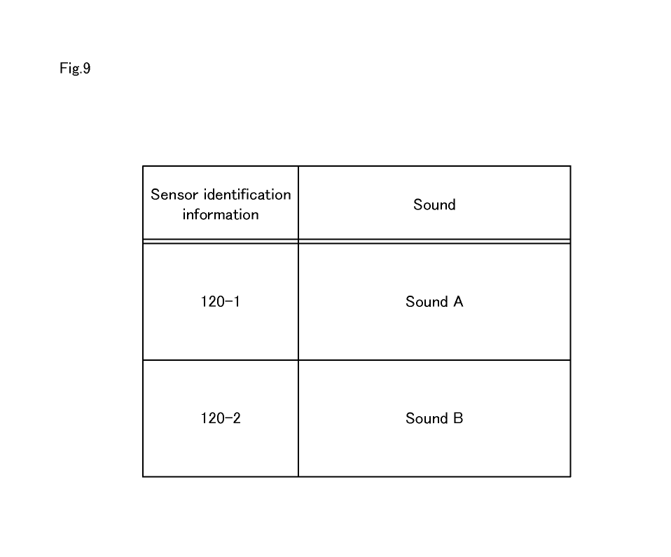

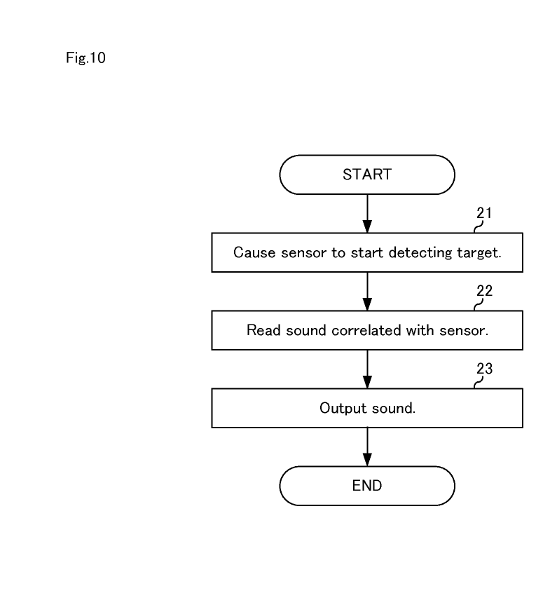

### BRIEF DESCRIPTION OF DRAWINGS

[FIG. 1] is a schematic diagram showing an electronic device according to an embodiment of the present invention.

[FIG. 2] is a schematic diagram showing an example of sensor identification information and icons correlatively stored in a storage section shown in FIG. 1.

[FIG. 3] is a flow chart describing an example of a notification method for the electronic device shown in FIG. 1.

[FIG. 4] is a schematic diagram showing an example of a screen of a display section that displays an icon that depicts a human face.

[FIG. 5] is a schematic diagram showing an example of a screen of the display section that displays an icon that depicts a hand.

[FIG. 6] is a flow chart describing another example of the notification method for the electronic device shown in FIG. 1.

[FIG. 7] is a schematic diagram showing an example of the screen of the display section that displays an instruction.

[FIG. 8] is a schematic diagram showing an electronic device according to another embodiment of the present invention.

[FIG. 9] is a schematic diagram showing an example of sensor identification information and sounds correlatively stored in a storage section shown in FIG. 8.

[FIG. 10] is a flow chart describing a notification method for the electronic device shown in FIG. 8.

### BEST MODES THAT CARRY OUT THE INVENTION

Next, with reference to the accompanying drawings, embodiments of the present invention will be described.

FIG. 1 is a schematic diagram showing an electronic device according to an embodiment of the present invention.

As shown in FIG. 1, electronic device 100 according to this embodiment is provided with sensors 120-1 to 120-2, storage section 130, and display section 140.

Sensors 120-1 to 120-2 detect motion of a target or shape of a target or motion and shape of a target. Sensors 120-1 to 120-2 independently detect a target. For example, sensor 120-1 detects the shape of a human face, whereas sensor 120-2 detects the motion of a human hand. Sensors 120-1 to 120-2 may be cameras having an image capturing function or motion sensors.

If sensors 120-1 to 120-2 are cameras, differential information that represents the difference between the position of each target that sensors 120-1 to 120-2 are capturing and the position where they need to be placed to detect the target may be output to display section 140.

While sensors 120-1 to 120-2 are performing a detecting operation, they output information that represents their operation to display section 140.

If sensors 120-1 to 120-2 detect the motion of a target, they output information that represents the motion of the target to display section 140.

Alternatively, sensors 120-1 to 120-2 may not be mounted on electronic device 100, but may be wire-connected or wirelessly connected to electronic device 100.

The electronic device shown in FIG. 1 is provided with two sensors. Alternatively, the electronic device may be provided with one sensor. Further alternatively, the electronic device may be provided with three or more sensors.

Display section 140 is a display or the like that displays information. If sensors 120-1 to 120-2 notify display section 140 that they are performing a detecting operation, display section 140 reads icons corresponding to sensors 120-1 to 120-2 from storage section 130.

Storage section 130 has correlatively stored sensor identification information that identifies sensors 120-1 to 120-2 and icons corresponding thereto.

FIG. 2 is a schematic diagram showing an example of sensor identification information and icons correlatively stored in storage section 130 shown in FIG. 1.

As shown in FIG. 2, storage section 130 shown in FIG. 1 has correlatively stored sensor identification information and icons. FIG. 2 shows an example of two sets of correlated items. Alternatively, the number of sets of correlated items may be one. Further alternatively, the number of sets of correlated items may be three or more. Thus, the number of sets of correlated items corresponds to the number of sensors.

Sensor identification information has been uniquely assigned to sensors 120-1 to 120-2. As long as items of sensor identification information can be distinguished from each other, the sensor identification information may be composed of numerical characters, alphabet characters, or alphanumeric characters.

Like ordinary icons, the icons shown in FIG. 2 are small images composed of a simple graphic symbol and are displayed on the screen of display section 140. Since the size of each icon shown in FIG. 2 is much smaller than the size of the display area on the screen of display section 140, any icon displayed on the screen of display section 140 does not hide an image displayed thereon.

As shown in FIG. 2, sensor identification information “120-1” and an icon depicting human face have already been correlatively stored. This means that while the sensor having sensor identification information “120-1” is performing a detecting operation, display section 140 displays an icon depicting a human face. In addition, sensor identification information “120-2” and an icon depicting human hand have already been correlatively stored. This means that while the sensor having sensor identification information “120-2” is performing a detecting operation, display section 140 displays an icon depicting a human hand.

For example, if the correlated items shown in FIG. 2 have been stored in storage section 130 and display section 140 is notified that sensor 120-1 having sensor identification information “120-1” is performing a detecting operation, display section 140 reads an icon depicting human face correlated with sensor identification information “120-1” from storage section 130. If display section 140 is notified that sensor 120-2 having sensor identification information “120-2” is performing a detecting operation, display section 140 reads an icon depicting human hand correlated with sensor identification information “120-2” from storage section 130.

Display section 140 displays an icon that has been read from storage section 130. At this point, display section 140 displays the icon in a peripheral display area on the screen.

If sensors 120-1 to 120-2 output motion information to display section 140, display section 140 may display an icon corresponding to the motion information. In this case, storage section 130 has stored an icon corresponding to motion information. For example, if sensor 120-2 is a sensor that detects the motion of a human hand, storage section 130 has stored a moving picture that depicts a moving hand as an icon displayed on the screen of display section 140. If sensor 120-2 outputs motion information that denotes that it is detecting a moving hand to display section 140, it may display an icon (a moving picture that represents a moving hand) corresponding to the motion information that has been read from storage section 130.

If sensors 120-1 to 120-2 output differential information to display section 140, display section 140 displays an instruction that causes the position of sensors 120-1 to 120-2 to be moved to a position where they need to be placed in order to detect a target corresponding to the differential information. This process will be described later in detail.

Next, a notification method for electronic device 100 shown in FIG. 1 will be described.

FIG. 3 is a flow chart describing an example of the notification method for electronic device 100 shown in FIG. 1. Now, it is assumed that the correlated items shown in FIG. 2 have been stored in storage section 130 shown in FIG. 1. In addition, it is assumed that sensors 120-1 to 120-2 are cameras and they detect the shape and motion of a target being captured.

First, when sensor 120-1 starts performing a detecting operation for a target being captured, sensor 120-1 notifies display section 140 of the operation at step 1.

Thereafter, display section 140 reads an icon depicting a human face correlated with sensor identification information of sensor 120-1 from correlated items stored in storage section 130 at step 2.

Thereafter, display section 140 displays the icon depicting a human face that has been read from storage section 130 in a peripheral display area on the screen at step 3.

FIG. 4 is a schematic diagram showing an example of the screen of display section 140 that displays an icon depicting a human face.

As shown in FIG. 4, icon 200 depicting a human face is displayed in a peripheral display area on display section 140. At this point, as shown in FIG. 4, since icon 200 is smaller than the display area on the screen of display section 140 and is displayed in a peripheral display area on the screen, icon 200 does not hide the entire display area on the screen of display section 140. Thus, icon 200 does not disturb the user's current operation.

Likewise, when sensor 120-2 starts performing a detecting operation for a target being captured, sensor 120-2 notifies display section 140 of the operation at step 1.

Thereafter, display section 140 reads an icon depicting a human hand correlated with sensor identification information of sensor 120-2 from correlated items stored in storage section 130 at step 2.

Thereafter, display section 140 displays the icon depicting a human hand that has been read from storage section 130 in a peripheral display area on the screen.

FIG. 5 is a schematic diagram showing an example of the screen of display section 140 that displays an icon depicting a human hand.

As shown in FIG. 5, icon 210 depicting a human hand is displayed in a peripheral display area on display section 140. At this point, as shown in FIG. 5, since icon 210 is smaller than the display area on the screen of display section 140 and is displayed in a peripheral display area on the screen, icon 210 does not hide the entire display area on the screen of display section 140. Thus, icon 210 does not disturb the user's current operation.

Icons displayed on the screen of display section 140 are not limited as long as the user can recognize that sensors 120-1 to 120-2 are performing a detecting operation. For example, icons displayed on the screen of display section 140 may be those that blink.

FIG. 6 is a flow chart describing another example of the notification method for electronic device 100 shown in FIG. 1. Now, it is assumed that the correlated items shown in FIG. 2 have been stored in storage section 130 shown in FIG. 1. In addition, it is assumed that sensor 120-1 is a camera that detects a human face being captured.

First, when sensor 120-1 starts performing a detecting operation for a target being captured, sensor 120-1 notifies display section 140 of the operation at step 11.

Thereafter, display section 140 reads an icon depicting a human face correlated with sensor identification information of sensor 120-1 from correlated items stored in storage section 130 at step 12.

Thereafter, display section 140 displays the icon depicting a human face that has been read from storage section 130 in a peripheral display area on the screen at step 13.

Thereafter, sensor 120-1 determines whether or not the face being captured is placed at a position where sensor 120-1 can detect the face at step 14. In other words, sensor 120-1 determines whether or not to correct the position of the face corresponding to the position of the camera.

If the entire face needs to be placed in a predetermined range (hereinafter referred to as the detection frame) of an image being captured, sensor 120-1 determines whether or not the face is placed in the predetermined range. If the entire face being captured is not placed in the detection frame, sensor 120-1 determines that the position of the face corresponding to the position of the camera needs to be corrected. In contrast, if the entire face being captured is placed in the detection frame, sensor 120-1 determines that the position of the face corresponding to the position of the camera does not need to be corrected.

If sensor 120-1 determines that the position of the face corresponding to the position of the camera needs to be corrected, sensor 120-1 calculates how the position of the face corresponding to the position of the camera needs to be moved (corrected). In other words, sensor 120-1 calculates how the position of the face corresponding to the position of the camera needs to be moved (corrected) such that the entire face is placed in the detection frame.

For example, if part of the face being captured protrudes from the left boundary of the detection frame, sensor 120-1 calculates that the position of the face corresponding to the position of the camera needs to be moved in the left direction of the camera. If part of the face being captured protrudes from the lower boundary of the detection frame, sensor 120-1 calculates that the position of the face corresponding to the position of the camera needs to be moved in the upper direction of the camera.

Thereafter, the differential information is output as the calculation result from sensor 120-1 to display section 140.

Thereafter, an instruction based on the differential information that has been output from sensor 120-1 is displayed on the screen of display section 140 at step 15.

FIG. 7 is a schematic diagram showing an example of the screen of display section 140 that displays an instruction.

As shown in FIG. 7, instruction 220 is displayed beside icon 200 displayed on the screen of display section 140. Instruction 220 is displayed based on the differential information that has been output from sensor 120-1.

For example, if sensor 120-1 outputs differential information that denotes that the user needs to move the position of the face corresponding to the position of the camera in the left direction of the camera, instruction 200 that denotes that “Move your face in the left direction a little.” is displayed on the screen of display section 140 as shown in FIG. 7.

The instruction allows the user to recognize the position of a target that sensors 120-1 to 120-2 can detect.

Display section 140 shown in FIG. 4, FIG. 5, and FIG. 7 is placed in the landscape orientation. Alternatively, display section 140 may be placed in the portrait orientation like a display used for mobile terminals.

Besides icons displayed on the screen of display section 140, sound notification may be performed.

FIG. 8 is a schematic diagram showing an electronic device according to another embodiment of the present invention.

As shown in FIG. 8, electronic device 101 according to this embodiment is provided with storage section 131 instead of storage section 130 of electronic device 100 shown in FIG. 1. Electronic device 101 is also provided with sound output section 150.

Sound output section 150 can output sound of a speaker or the like to the outside. If sensors 120-1 to 120-2 notify sound output section 150 that they are performing a detecting operation, sound output section 150 reads a sound correlated with the notified sensor from storage section 131.

Storage section 131 has correlatively stored sensor identification information that identifies sensors 120-1 to 120-2 and sounds corresponding thereto.

FIG. 9 is a schematic diagram showing an example of sensor identification information and sounds correlatively stored in storage section 131 shown in FIG. 8.

As shown in FIG. 9, storage section 131 shown in FIG. 8 has correlatively stored sensor identification information and sounds. FIG. 9 shows an example of two sets of correlated items. Alternatively, the number of sets of correlated items may be one. Further alternatively, the number of sets of correlated items may be three or more. Thus, the number of sets of correlated items corresponds to the number of sensors.

The sensor identification information is the same as that shown in FIG. 2.

Sounds may be audio files that serve to output real sounds. Alternatively, sounds may represent storage locations at which audio files are stored (memory addresses, network sites, and so forth).

As shown in FIG. 9, sensor identification information “120-1” and sound “Sound A” have been correlatively stored. This means that while the sensor having sensor identification information “120-1” is performing a detecting operation, sound output section 150 outputs sound “Sound A”. In addition, sensor identification information “120-2” and sound “Sound B” have been correlatively stored. This means that while the sensor having sensor identification information “120-2” is performing a detecting operation, sound output section 150 outputs sound “Sound B”.

For example, if the correlated items shown in FIG. 9 have been stored in storage section 131 and sound output section 150 is notified that sensor 120-1 having sensor identification information “120-1” is performing a detecting operation, sound output section 150 reads sound “Sound A” correlated with sensor identification information “120-1” from storage section 131. If sound output section 150 is notified that sensor 120-2 having sensor identification information “120-2” is performing a detecting operation, sound output section 150 reads sound “Sound B” correlated with sensor identification information “120-2” from storage section 131.

Sound output section 150 outputs sounds that have been read from storage section 131.

Next, a notification method for electronic device 101 shown in FIG. 8 will be described.

FIG. 10 is a flow chart describing the notification method for electronic device 101 shown in FIG. 8. Now, it is assumed that the correlated items shown in FIG. 9 have been stored in storage section 131 shown in FIG. 8. In addition, it is assumed that sensors 120-1 to 120-2 are cameras and that they detect the shape and motion of a target being captured.

First, when sensor 120-1 starts performing a detecting operation for a target being captured, sensor 120-1 notifies sound output section 150 of the operation at step 21.

Thereafter, sound output section 150 reads sound “Sound A” correlated with sensor identification information of sensor 120-1 from correlated items stored in storage section 131 at step 21.

Sound “Sound A” that has been read from sound output section 150 is output to the outside of electronic device 101 at step 23.

Likewise, when sensor 120-2 starts performing a detecting operation for a target being captured, sensor 120-2 notifies sound output section 150 of the operation at step 21.

Thereafter, sound output section 150 reads sound “Sound B” correlated with sensor identification information of sensor 120-2 from correlated items stored in storage section 131 at step 22.

Sound “Sound B” that has been read from sound output section 150 is output to the outside of electronic device 101 at step 23.

Thus, since sound output section 150 notifies the user that sensors 120-1 to 120-2 are performing a detecting operation, they do not affect an operation that he or she is performing on the screen of display section 140. As a result, the user can recognize the detecting operations of sensors 120-1 to 120-2.

Alternatively, the user may be notified with by vibration or by light (using for example an LED or the like) instead of by the forgoing icons and sounds.

Alternatively, electronic devices 100 and 101 may be devices that display information on a display equivalent to display section 140 such as a PC (Personal Computer), a television, or a mobile terminal and that allow the user to perform a predetermined operation corresponding to information that is displayed.

It should be noted that the foregoing process may be applied to an authentication process that compares the shape and/or motion of a detected target (face, hand, or the like) with those that have been registered, and successfully authenticates the target if they match.

If a process that causes a sensor to detect fingers that communicate in sign language, translates the detected finger motions into ordinary text, and displays the translated text on display section 140, is provided, the user can recognize the captured finger motions in sign language.

Thus, according to the present invention, the user can grasp a target that a sensor is detecting without it being necessary to stop performing his or her current operation on the screen of display section 140. For example, while the user is performing an operation on a web browser screen displayed on display section 140, if he or she moves to a face authentication page on which he or she needs to log in, the face authentication page will not hide the browser screen. Thus, when the user selects an “authentication” key that is displayed on the screen of display section 140 and then the face authentication starts, he or she will not need to stop his or her current operation on the browser screen.

The process performed by each structural component of electronic device 100, 101 may be performed by a logic circuit manufactured corresponding to the purpose. A computer program that codes procedures of processes (hereinafter referred to as the program) may be recorded on a record medium that can be read by electronic device 100, 101 and executed. The record medium from which data can be read by electronic device 100, 101 includes a movable record medium such as a floppy disk (registered trademark), a magneto-optical disc, a DVD, or a CD; a memory built in electronic device 100, 101 such as a ROM or a RAM; or an HDD. The program recorded on the record medium is read by a CPU (not shown) with which electronic device 100, 101 is provided and the foregoing processes are performed under the control of the CPU. The CPU operates as a computer that executes the program that is read from the record medium on which the program is recorded.

With reference to the embodiments, the present invention has been described. However, it should be understood by those skilled in the art that the structure and details of the present invention may be changed in various manners without departing from the scope of the present invention.

The present application claims priority based on Japanese Patent Application JP 2011-072485 filed on Mar. 29, 2011, the entire contents of which are incorporated herein by reference in its entirety.

1. An electronic device comprising:
a sensor that detects motion of a target or shape of a target or motion and shape of a target; and
a display section that displays an icon that denotes that said sensor is detecting the target.

2. The electronic device as set forth in claim 1, further comprising:
a plurality of said sensors,
wherein said display section displays an icon corresponding to a sensor, that is detecting the target, from among the sensors.

3. The electronic device as set forth in claim 1,
wherein said sensor is a camera having an image capturing function and detects motion of the target or shape of the target or motion and shape of the target being captured.

4. The electronic device as set forth in claim 3,
wherein if said sensor detects a face, said display section displays an instruction that causes the position of the face being captured to be moved to a position where said sensor needs to be placed to detect the face.

5. The electronic device as set forth in claim 1,
wherein said display section displays said icon in a peripheral display area of the screen.

6. The electronic device as set forth in claim 1,
wherein while said sensor is detecting the motion of the target, said display section displays an icon that depicts the motion.

7. The electronic device as set forth in claim 1,
wherein said display section is replaced with a sound output section that outputs a sound that denotes that said sensor is detecting the target.

8. A notification method that notifies a user who uses an electronic device of information, comprising processes of:
causing a sensor to detect motion of a target or shape of a target or motion and shape of a target; and
displaying an icon that denotes that said sensor is detecting the target.

9. The notification method as set forth in claim 8, further comprising the process of:
if said electronic device is provided with a plurality of sensors,
displaying an icon corresponding to a sensor, that is detecting the target, from among the sensors.

10. The notification method as set forth in claim 8, further comprising the process of:
if said sensor is a camera that has an image capturing function,
detecting motion of the target or shape of the target or motion and shape of the target being captured.

11. The notification method as set forth in claim 10, further comprising the process of:
if said sensor detects a face,
displaying an instruction that causes the position of the face being captured to be moved to a position where said sensor needs to be placed to detect the face.

12. The notification method as set forth in claim 8, further comprising the process of:
displaying said icon in a peripheral display area of the screen.

13. The notification method as set forth in claim 8, further comprising the process of:
while said sensor is detecting the motion of the target,
displaying an icon that depicts the motion.

14. The notification method as set forth in claim 8,
wherein instead of displaying said icon, a sound is output that denotes that said sensor is detecting the target.

15-21. (canceled)
